(19) United States
(12) Patent Application Publication
(10) Pub. No.: US 2021/0394376 A1
(43) Pub. Date: Dec. 23, 2021

(54) Hair Clipper with Improved Housing

(71) Applicants: Christopher J. Braun, Racine, WI (US); Joseph Novak, Milwaukee, WI (US); Jeffrey D. Gross, Kenosha, WI (US); Jassen R. Miller, Trevor, WI (US)

(72) Inventors: Christopher J. Braun, Racine, WI (US); Joseph Novak, Milwaukee, WI (US); Jeffrey D. Gross, Kenosha, WI (US); Jassen R. Miller, Trevor, WI (US)

(21) Appl. No.: 17/407,954

(22) Filed: Aug. 20, 2021

Related U.S. Application Data
(63) Continuation-in-part of application No. 29/756,803, filed on Oct. 30, 2020.
Application No. 29/756,803 is a continuation-in-part of application No. 29/735,659, filed on May 22, 2020.

(51) Int. Cl. B26B 19/38; B26B 19/06

(52) U.S. Cl. CPC B26B 19/3853; B26B 19/06; B26B 19/3873; B26B 19/3886

(57) ABSTRACT

A hair cutter with an improved handle is described. The handle includes a neck and upper and lower housings that together form a surface with a gripping portion. The handle extends longitudinally from a cutting end to a handle or gripping end opposite a blade assembly at the cutting end. The gripping portion of the handle facilitates gripping and/or handling the handle. The location of the griping portion and the size relative to the handle allows for improved grasping for users. The neck is configured to deflect hair and/or debris away from the hair cutter and includes a shape and size relative to the handle allowing for reduced weight compared to a standard hair shield.

### CROSS-REFERENCE TO RELATED PATENT APPLICATION

This application is a Continuation-in-Part of U.S. Design application Ser. No. 29/735,659, filed May 22, 2020, and U.S. Design application Ser. No. 29/756,803, filed Oct. 30, 2020 which are incorporated herein by reference in their entirety.

### BACKGROUND OF THE INVENTION

The present invention relates generally to the field of hair cutters or clippers. The present invention relates specifically to hair cutters or clippers with a modified housing.

### SUMMARY OF THE INVENTION

One embodiment of the invention relates to a cutter having a blade assembly and a handle. The blade assembly defines a cutting end with a stationary blade and an oscillating blade that oscillates cutting teeth over the stationary blade to cut hair. The handle has an upper housing and a lower housing, each having an outer surface including a gripping portion that align and together define a grip. The handle further includes a gripping end opposing the cutting end and a neck having a generally concave shape and configured to deflect cut hair away from the cutter. The lower housing couples to the upper housing to define a first housing width at the gripping end and a second housing width at the cutting end. The second housing width is greater than the first housing width. The grip includes a plurality of ridges extending around a portion of the handle and positioned between the cutting end and the gripping end.

Another embodiment of the invention relates to a hair cutter having a blade assembly and a handle. The blade assembly defines a cutting end with a stationary blade and an oscillating blade that oscillates cutting teeth over the stationary blade to cut hair. The handle has an upper housing and a lower housing, each having an outer surface including a gripping portion that align and together define a grip. The handle further includes a gripping end opposing the cutting end and a neck having a shape and configured to deflect cut hair away from the hair cutter. The grip includes a plurality of ridges extending around a portion of the handle and positioned between the cutting end and the gripping end. The grip includes a plurality of ridges extending around a portion of the handle and positioned between the cutting end and the gripping end.

Another embodiment of the invention relates to a cutter having a blade assembly and a handle. The blade assembly defines a first end with a stationary blade and an oscillating blade that oscillates cutting teeth over the stationary blade to cut hair. The handle has an upper housing and a lower housing, each having an outer surface including a gripping portion that align and together define a grip. The handle further includes a second end opposing the first end and a neck having a shape and configured to deflect cut hair away from the cutter. The lower housing couples to the upper housing to define a first housing width at the second end and a second housing width at the first end. The second housing width is greater than the first housing width. The upper housing further includes a top side and the lower housing further includes a bottom side. The grip includes a plurality of ridges spaced apart and extending around the handle reaching the bottom side and positioned between the first and second end of the cutter.

Additional features and advantages will be set forth in the detailed description which follows, and, in part, will be readily apparent to those skilled in the art from the description or recognized by practicing the embodiments as described in the written description and claims hereof, as well as the appended drawings. It is to be understood that both the foregoing general description and the following detailed description are exemplary.

The accompanying drawings are included to provide further understanding and are incorporated in and constitute a part of this specification. The drawings illustrate one or more embodiments and, together with the description, serve to explain principles and operation of the various embodiments.

### BRIEF DESCRIPTION OF THE DRAWINGS

This application will become more fully understood from the following detailed description, taken in conjunction with the accompanying figures, wherein like reference numerals refer to like elements in which:

FIG. 1 is a front perspective view of a hair clipper, according to an exemplary embodiment.

FIG. 2 is a rear perspective view of the hair clipper of FIG. 1, according to an exemplary embodiment.

FIG. 3 is a front side view of the hair clipper of FIG. 1, according to an exemplary embodiment.

FIG. 4 is a rear side view of the hair clipper of FIG. 1, according to an exemplary embodiment.

FIG. 5 is a right side view of the hair clipper of FIG. 1, according to an exemplary embodiment.

FIG. 6 is a left side view of the hair clipper of FIG. 1, according to an exemplary embodiment.

FIG. 7 is a top side view of the hair clipper of FIG. 1, according to an exemplary embodiment.

FIG. 8 is a bottom side view of the hair clipper of FIG. 1, according to an exemplary embodiment.

FIG. 9 is a front perspective view of a hair clipper, according to an exemplary embodiment.

FIG. 10 is a rear perspective view of the hair clipper of FIG. 9, according to an exemplary embodiment.

FIG. 11 is a front side view of the hair clipper of FIG. 9, according to an exemplary embodiment.

FIG. 12 is a rear side view of the hair clipper of FIG. 9, according to an exemplary embodiment.

FIG. 13 is a right side view of the hair clipper of FIG. 9, according to an exemplary embodiment.

FIG. 14 is a left side view of the hair clipper of FIG. 9, according to an exemplary embodiment.

FIG. 15 is a top side view of the hair clipper of FIG. 9, according to an exemplary embodiment.

FIG. 16 is a bottom side view of the hair clipper of FIG. 9, according to an exemplary embodiment.

### DETAILED DESCRIPTION

Referring generally to the figures, various embodiments of a hair trimmer, cutter, or clipper shown as a hair clipper are shown. As discussed herein, Applicant has developed a number of improvements to the housing of the hair clipper. In one embodiment, the hair clipper includes a handle with an upper housing and a lower housing and a blade assembly. The hair clipper includes a shape defined by a greater width at a cutting end adjacent to the blade assembly than a width at the gripping end that opposes the cutting end. The upper and lower housing each include a gripping portion that together defines a grip. The location of the grip and size relative to the handle allows for improved grasping for users.

In another embodiment, an improved neck portion is coupled to the upper housing at the cutting end and extending toward the blade assembly. The neck portion includes a shape configured to prevent cut hair or other debris from entering or interfering with internal components of the hair clipper. In a specific embodiment, the neck includes a concave shape to deflect away the hair or other debris. The shape and size of the neck relative to the handle allows for reduced weight compared to a standard hair shield that may extend across the width of the handle.

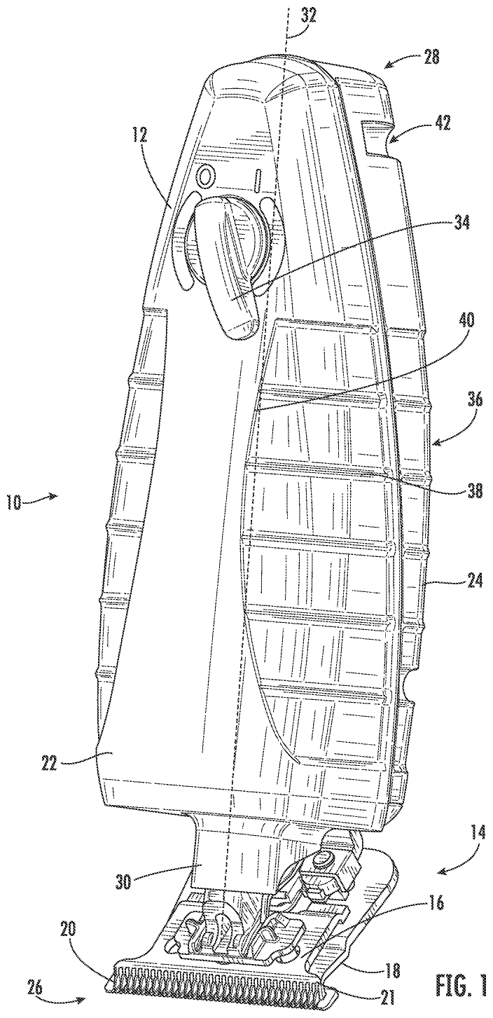

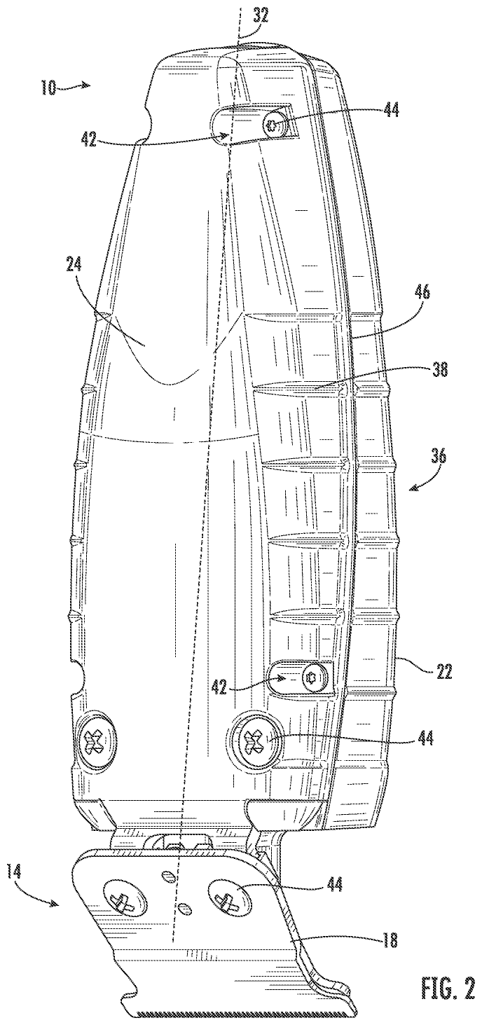

Referring to FIGS. 1 and 2, various aspects of a hair trimmer, cutter, or clipper, shown as clipper 10 are shown. Clipper 10 includes a handle 12 coupled to a blade assembly 14. Blade assembly 14 includes an upper blade or cutter 16 and a lower blade 18. Upper blade 16 includes teeth 20 extending from a front edge 21 of upper blade 16. Upper blade 16 oscillates over lower blade 18 while teeth 20 cooperate with lower blade 18 to capture hair follicles and cut hair. Clipper 10 includes various components for operating clipper 10 within handle 12 (e.g. motor, circuit board, battery etc.).

Handle 12 includes an upper housing 22 coupled to a lower housing 24 extending along a longitudinal axis 32 between a first end or cutting end 26 a second end or gripping end 28. The first end or cutting end 26 is located adjacent to the blade assembly 14 and the second end or gripping end 28 opposes the cutting end 26. Handle 12 further includes a neck 30 coupled to upper housing 22 and extending away from upper housing 22 in a direction toward blade assembly 14. Neck 30 has a generally concave shape and is configured to deflect hair and/or other debris away from the internal components of clipper 10.

In various embodiments, handle 12 is a single, continuous, and or integral component, such that upper housing 22 and lower housing 24 are permanently joined and/or fabricated as a continuous component or unitary part. In some embodiments, upper housing 22 is fabricated separately from lower housing 24 and upper housing 22 is joined or coupled to lower housing 24 at and a housing edge 46 using an attachment mechanism, shown as fasteners 44. Lower housing 24 includes one or more recesses 42 sized to receive and at least partially surround fasteners 44.

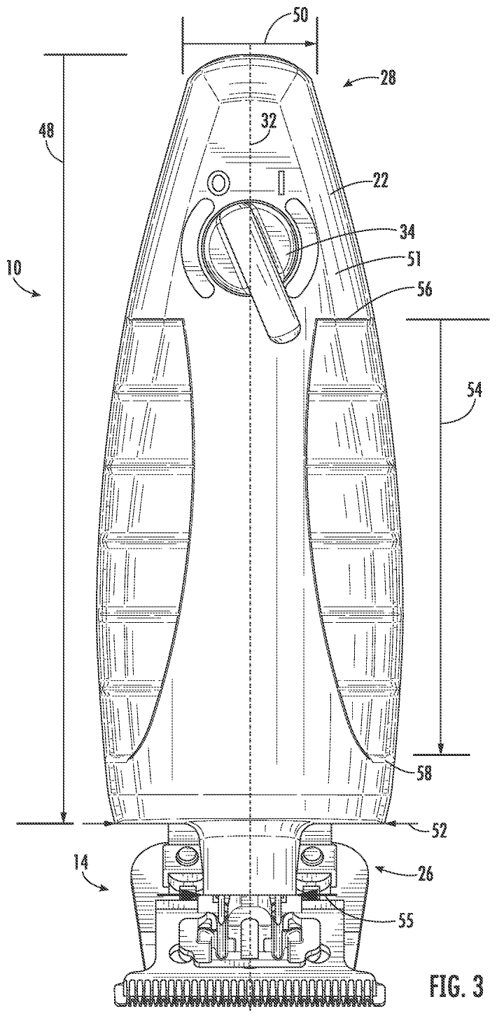

Referring to FIGS. 2 and 3, upper housing 22 includes a power control, shown as power switch 34. The power switch 34 includes a base portion and a switch portion. Handle 12 further includes a gripping portion 36 extending across a portion of upper housing 22 and lower housing 24. Gripping portion 36 is defined by a top edge 56, a curved inner edge 40 and a bottom edge 58 and includes a plurality of ridges 38. Ridges 38 extend away from curved inner edge 40 around handle 12 towards housing edge 46 where upper housing 22 and lower housing 24 meet.

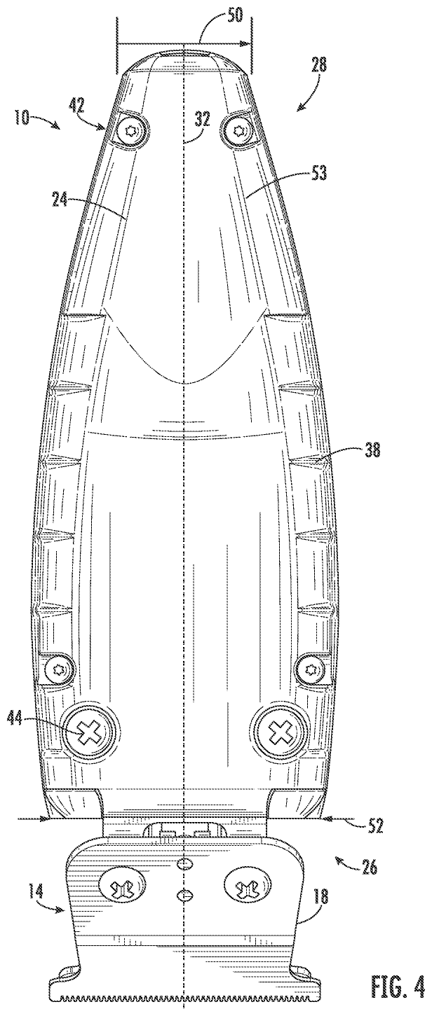

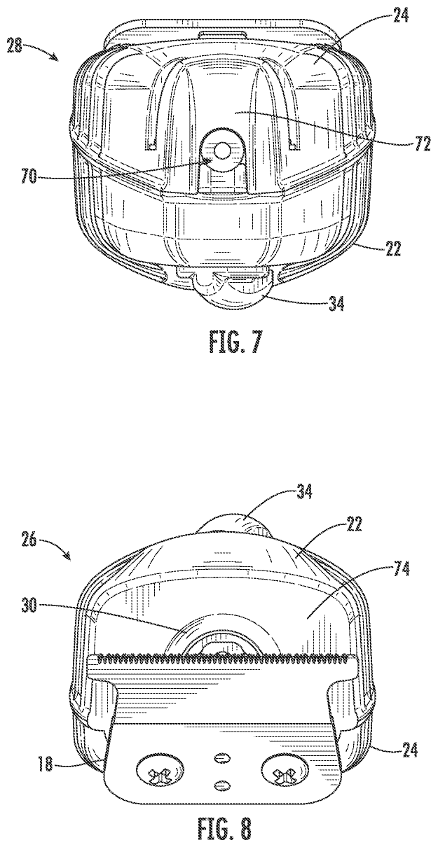

FIGS. 3-8 show various orthogonal views of clipper 10 and demonstrate relative dimensions of clipper 10. Handle 12 extends along longitudinal axis 32 between a top surface 72 and a bottom surface 74 (see e.g. FIGS. 7 and 8) of handle 12 defining a first housing length, shown as 48. A second housing length, shown as 68, extends between top surface 72 and a lower edge 66 of neck 30. In a specific embodiment, the first housing length is specifically between 88% and 98% of the second housing length, more specifically between 90% and 93% of the second housing length and in such embodiments the first housing length is about 4.5 inches (plus or minus 0.05 inches). The gripping portion 36 extends between top edge 56 and bottom edge 58 defining a gripping portion length 54. In a specific embodiment, gripping portion length 54 is between 50% and 60% of the first housing length and more specifically between 56% and 59% of the first housing length, in such embodiments gripping portion length 54 is about 2.6 inches (plus or minus 0.05 inches).

An orthogonal angle to longitudinal axis 32 defines a first housing width (e.g. between left and right sides of handle 12), shown as 50 located at the gripping end 28 and a second housing width, shown as 52 and located at the cutting end 26. In a specific embodiment, the first housing width is specifically between 45% and 55% of the second housing width, more specifically between 49% and 51% of the second housing width and in such embodiments the first housing width is about 0.75 inches (plus or minus 0.05 inches).

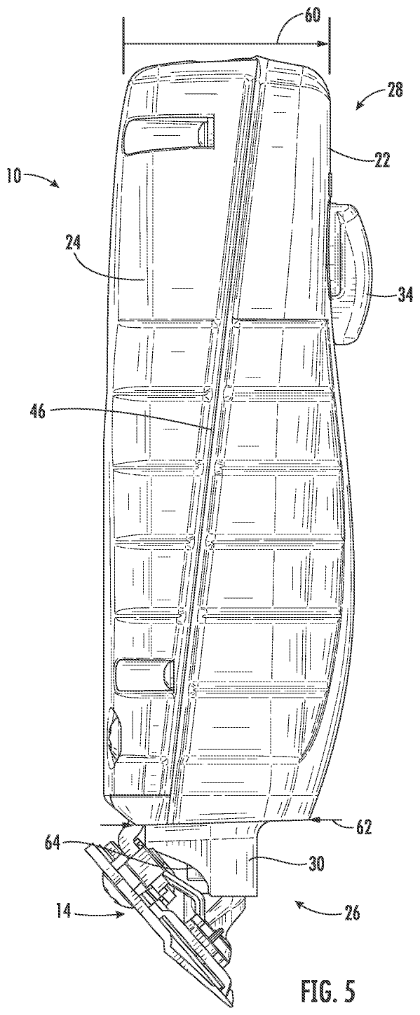

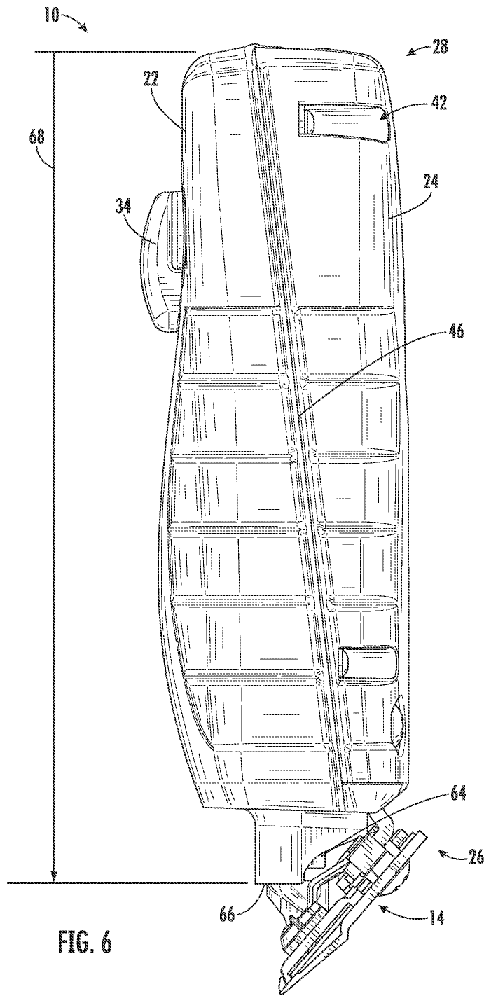

Referring to FIG. 5, a first housing height, shown as 60 is defined between a top side 51 of upper housing 22 and bottom side 53 of lower housing 24 at gripping end 28 and a second housing height, shown as 62 is located at cutting end 26. In a specific embodiment, the second housing height is specifically between 80% and 90% of the first housing height, more specifically between 85% and 90% of the first housing height and in such embodiments the second housing height is about 1.15 inches (plus or minus 0.05 inches). Referring to FIG. 6, neck 30 further includes a curved edge 64 extending away from lower edge 66 generally toward housing edge 46. A neck width 55 is defined between left and right sides of neck 30. In a specific embodiment, neck width 55 is specifically between 30% and 40% of the second housing width, more specifically between 36% and 38% of the second housing width and in such embodiments neck width 55 is about 0.555 inches (plus or minus 0.05 inches).

Referring to FIGS. 7 and 8 a top side view and bottom side view of clipper 10 are shown. In some embodiments, top surface 72 located at gripping end 28 includes an electric charging port 70. Charging port 70 extends through handle 12 and is electronically coupled to internal components of clipper 10 (e.g. a battery).

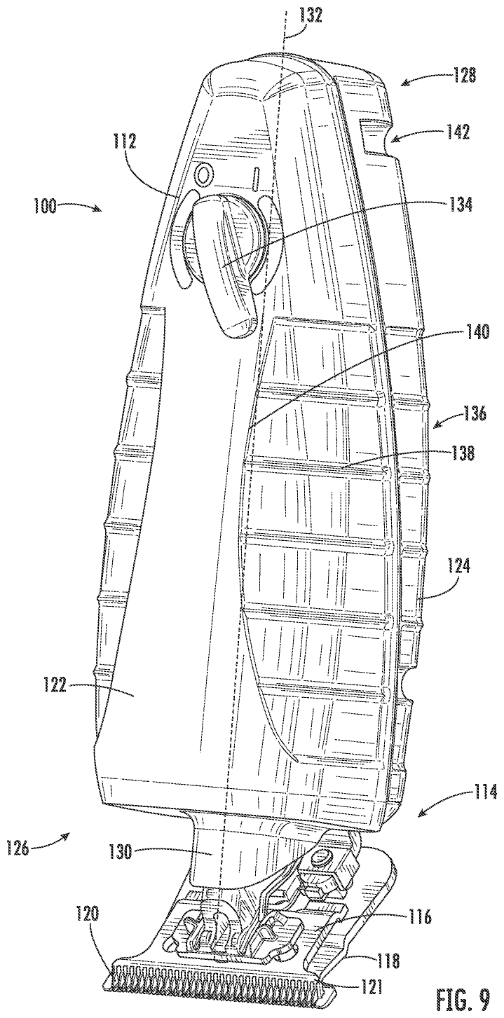

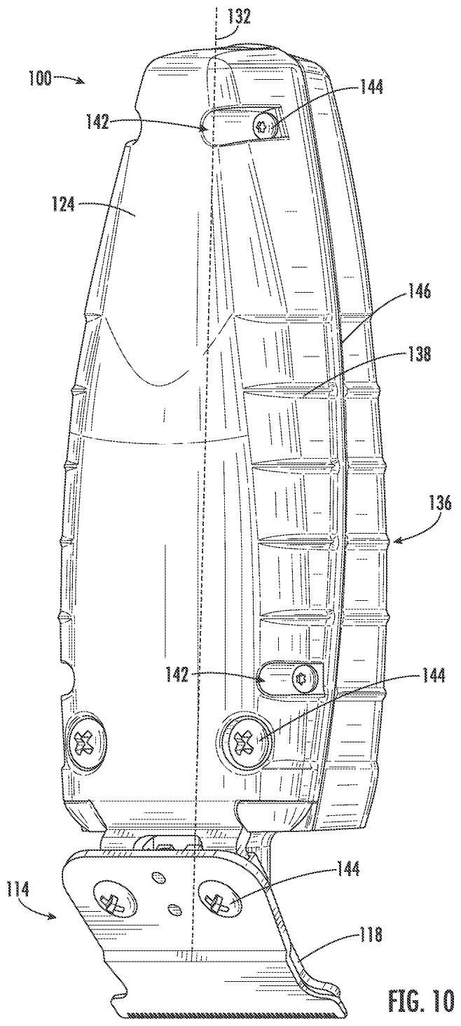

Referring to FIGS. 9 and 10, various aspects of a hair trimmer, cutter, or clipper, shown as clipper 100 are shown. In general, clipper 100 is substantially the same as clipper 10 except for the differences discussed herein. Clipper 100 includes a handle 112 coupled to a blade assembly 114. Blade assembly 114 includes an upper blade or cutter 116 and a lower blade 118. Upper blade 116 includes teeth 120 extending from a front edge 121 of upper blade 116. Upper blade 116 oscillates over lower blade 118 while teeth 120 cooperate with lower blade 118 to capture hair follicles and cut hair.

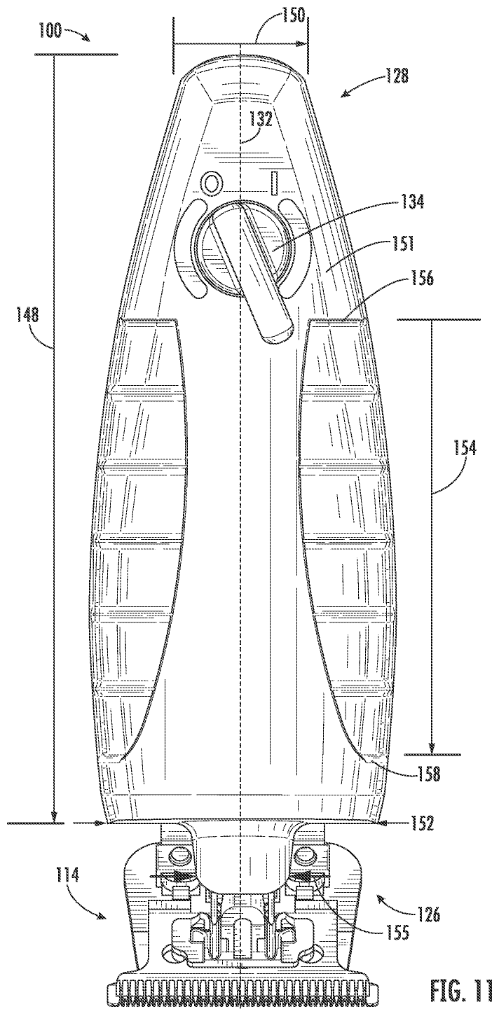

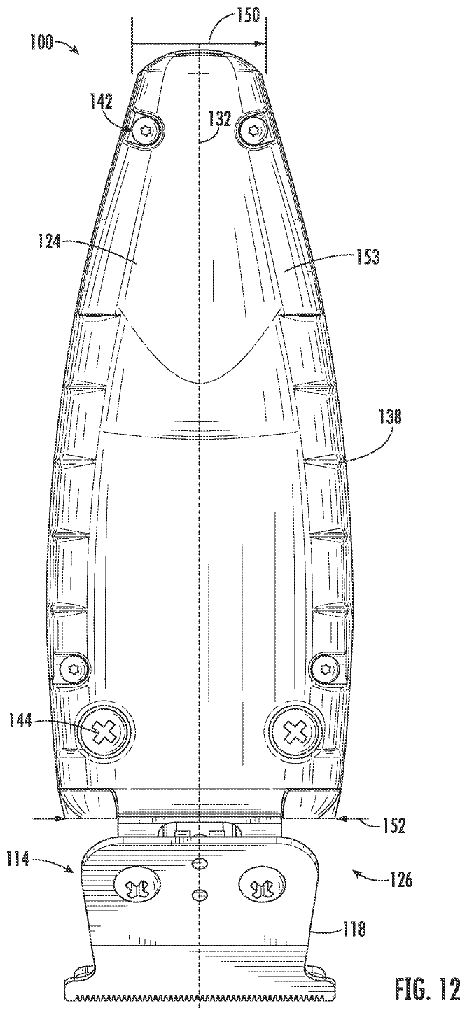

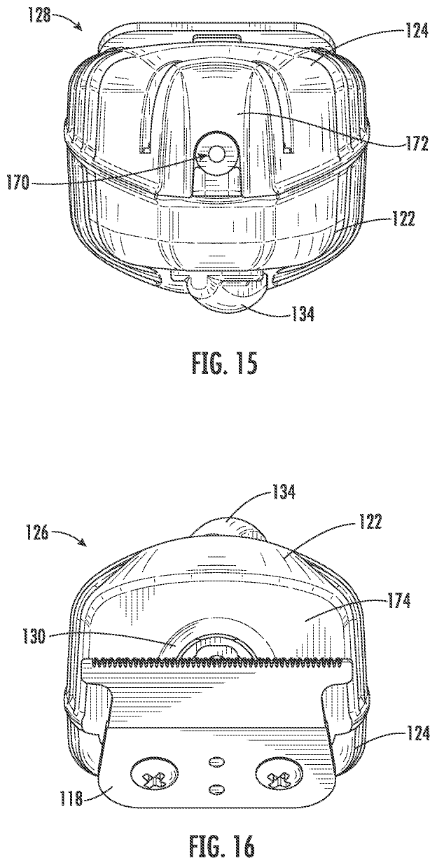

FIGS. 11-16 show various orthogonal views of clipper 100 and demonstrate relative dimensions of clipper 100. Handle 112 extends along a longitudinal axis 132 between a top surface 172 and a bottom surface 174 (see e.g. FIGS. 15 and 16) of handle 112 defining a first housing length, shown as 148. A second housing length, shown as 168, extends between top surface 172 and a lower edge 166 of neck 130. In a specific embodiment, the first housing length is specifically between 88% and 98% of the second housing length, more specifically between 90% and 93% of the second housing length and in such embodiments the first housing length is about 4.5 inches (plus or minus 0.05 inches). The gripping portion 36 extends between top edge 156 and bottom edge 158 defining a gripping portion length 154. In a specific embodiment, gripping portion length 154 is between 50% and 60% of the second housing length and more specifically between 56% and 59% of the second housing length, in such embodiments gripping portion length 154 is about 2.6 inches (plus or minus 0.05 inches).

An orthogonal angle to longitudinal axis 132 defines a first housing width (e.g. between left and right sides of handle 112), shown as 150 located at the gripping end 128 and a second housing width, shown as 152 and located at the cutting end 126. In a specific embodiment, the first housing width is specifically between 45% and 55% of the second housing width, more specifically between 49% and 51% of the second housing width and in such embodiments the first housing width is about 0.75 inches (plus or minus 0.05 inches).

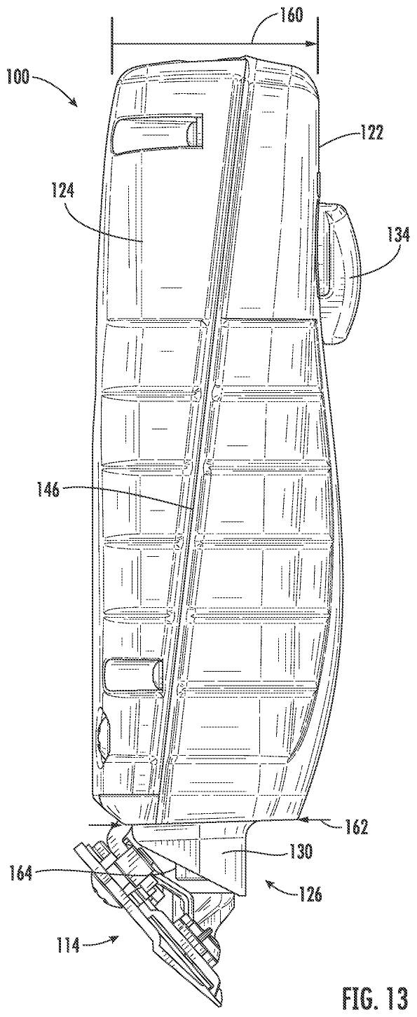

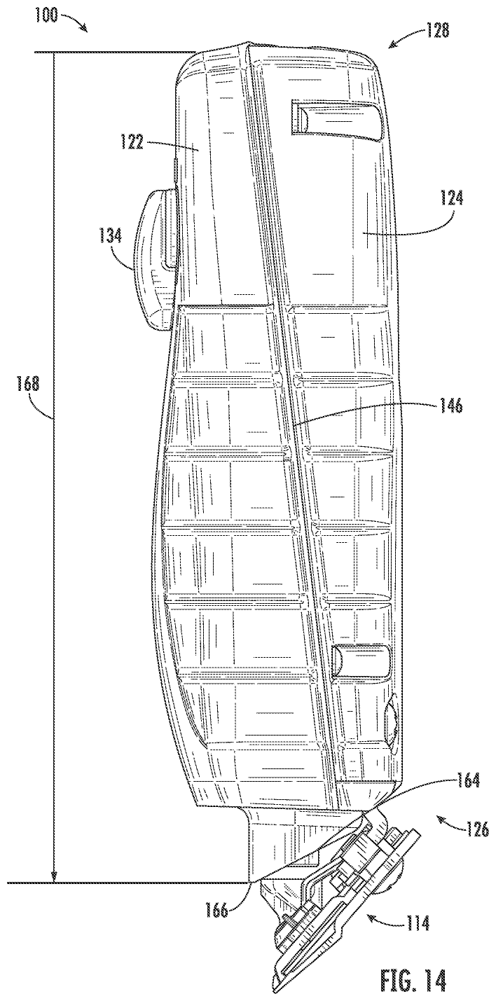

Referring to FIG. 13, a first housing height, shown as 160 is defined between a top side 151 of upper housing 122 and bottom side 153 of lower housing 124 at gripping end 128 and a second housing height, shown as 162 is located at cutting end 126. In a specific embodiment, the second housing is specifically between 80% and 90% of the first housing height, more specifically between 85% and 90% of the first housing height and in such embodiments the second housing height is about 1.15 inches (plus or minus 0.05 inches). Referring to FIG. 14, neck 130 further includes an edge 164 extending at an angle away from lower edge 166 generally toward housing edge 146. A neck width 155 is defined between left and right sides of neck 130. In a specific embodiment, neck width 155 is specifically between 30% and 40% of the second housing width, more specifically between 36% and 38% of the second housing width and in such embodiments neck width 155 is about 0.555 inches (plus or minus 0.05 inches).

Referring to FIGS. 15 and 16a top side view and bottom side view of clipper 100 are shown. In some embodiments, top surface 172 located at gripping end 128 includes a charging port 170. Charging port 170 extends through handle 12 and is electronically coupled to internal components of clipper 100 (e.g. a battery).

It should be understood that the figures illustrate the exemplary embodiments in detail, and it should be understood that the present application is not limited to the details or methodology set forth in the description or illustrated in the figures. It should also be understood that the terminology is for the purpose of description only and should not be regarded as limiting.

Further modifications and alternative embodiments of various aspects of the invention will be apparent to those skilled in the art in view of this description. Accordingly, this description is to be construed as illustrative only. The construction and arrangements, shown in the various exemplary embodiments, are illustrative only. Although only a few embodiments have been described in detail in this disclosure, many modifications are possible (e.g., variations in sizes, dimensions, structures, shapes and proportions of the various elements, values of parameters, mounting arrangements, use of materials, colors, orientations, etc.) without materially departing from the novel teachings and advantages of the subject matter described herein. Some elements shown as integrally formed may be constructed of multiple parts or elements, the position of elements may be reversed or otherwise varied, and the nature or number of discrete elements or positions may be altered or varied. The order or sequence of any process, logical algorithm, or method steps may be varied or re-sequenced according to alternative embodiments. Other substitutions, modifications, changes and omissions may also be made in the design, operating conditions and arrangement of the various exemplary embodiments without departing from the scope of the present invention.

Various embodiments of the invention relate to any combination of any of the features, and any such combination of features may be claimed in this or future applications. Any of the features, elements or components of any of the exemplary embodiments discussed above may be utilized alone or in combination with any of the features, elements or components of any of the other embodiments discussed above.

For purposes of this disclosure, the term “coupled” means the joining of two components directly or indirectly to one another. Such joining may be stationary in nature or movable in nature. Such joining may be achieved with the two members and any additional intermediate members being integrally formed as a single unitary body with one another or with the two members or the two members and any additional member being attached to one another. Such joining may be permanent in nature or alternatively may be removable or releasable in nature.

In various exemplary embodiments, the relative dimensions, including angles, lengths and radii, as shown in the Figures are to scale. Actual measurements of the Figures will disclose relative dimensions, angles and proportions of the various exemplary embodiments. Various exemplary embodiments extend to various ranges around the absolute and relative dimensions, angles and proportions that may be determined from the Figures. Various exemplary embodiments include any combination of one or more relative dimensions or angles that may be determined from the Figures. Further, actual dimensions not expressly set out in this description can be determined by using the ratios of dimensions measured in the Figures in combination with the express dimensions set out in this description.

What is claimed is:

1. A cutter, comprising:
a blade assembly defining a cutting end, the blade assembly comprising:
a stationary blade; and
an oscillating blade that oscillates cutting teeth over the stationary blade to cut hair;
a handle, including:
an upper housing, the upper housing including an outer surface, wherein the outer surface includes a first gripping portion;
a lower housing, the lower housing including an outer surface, wherein the outer surface of the lower housing includes a second gripping portion that aligns with the first gripping portion of the upper housing and together define a grip;
a gripping end opposing the cutting end; and
a neck having a generally concave shape and configured to deflect cut hair away from the cutter;
wherein the lower housing couples to the upper housing to define a first housing width at the gripping end and a second housing width at the cutting end, and wherein the second housing width is greater than the first housing width;
wherein the grip includes a plurality of ridges extending around a portion of the handle and positioned between the cutting end and the gripping end.

2. The cutter of claim 1, wherein the neck further includes an upper edge coupled to the upper housing, a lower edge opposing the upper edge and a pair of curved edges extending away from either side of the lower edge toward the lower housing.

3. The cutter of claim 2, wherein the pair of curved edges define a first and second side wall of the neck, wherein a neck width is defined between the first and second side walls and wherein the neck width is between 30% and 40% of the second housing width.

4. The cutter of claim 1, the upper housing further including a top surface at the gripping end and a bottom surface at the cutting end, wherein a housing length is defined between the top surface and bottom surface.

5. The cutter of claim 4, wherein the first gripping portion extends between a top edge and a bottom edge defining a gripping portion length and wherein the gripping portion length is at least 50% of the housing length.

6. The cutter of claim 1, the upper housing further including a top side, wherein the top side of the upper housing includes a power switch.

7. The cutter of claim 1, further including a top surface at the gripping end, the top surface including a charging port.

8. A hair cutter, comprising:
a blade assembly defining a cutting end, the blade assembly comprising:
a stationary blade; and
an oscillating blade that oscillates cutting teeth over the stationary blade to cut hair;
a handle, including:
an upper housing, the upper housing including an outer surface, wherein the outer surface includes a first gripping portion;
a lower housing, the lower housing including an outer surface, wherein the outer surface of the lower housing includes a second gripping portion that aligns with the first gripping portion of the upper housing and together define a grip;
a gripping end opposing the cutting end; and
a neck having a shape configured to deflect cut hair away from the hair cutter;
wherein the grip includes a plurality of ridges extending around a portion of the handle and positioned between the cutting end and the gripping end.

9. The hair cutter of claim 8, wherein the first gripping portion extends between a top edge and a bottom edge defining a gripping portion length.

10. The hair cutter of claim 9, the upper housing further including a top surface at the gripping end and a bottom surface at the cutting end, wherein a housing length is defined between the top surface and bottom surface and wherein the gripping portion length is at least 50% of the housing length.

11. The hair cutter of claim 10, wherein the gripping portion length is about 2.6 inches.

12. The hair cutter of claim 8, wherein the lower housing couples to the upper housing to define a first housing width at the gripping end and a second housing width at the cutting end, and wherein the second housing width is greater than the first housing width.

13. The hair cutter of claim 12, wherein the neck further includes an upper edge coupled to the upper housing, a lower edge opposing the upper edge and a pair of edges extending at an angle away from either side of the lower edge toward the lower housing.

14. The hair cutter of claim 13, wherein the pair of edges define a first and second side wall of the neck, wherein a neck width is defined between the first and second side walls and wherein the neck width is between 30% and 40% of the second housing width.

15. The hair cutter if claim 14, wherein the neck width is about 0.555 inches.

16. A cutter, comprising:
a blade assembly defining a first end, the blade assembly comprising:
a stationary blade; and
an oscillating blade that oscillates cutting teeth over the stationary blade to cut hair;
a handle, including:
an upper housing, the upper housing including an outer surface, wherein the outer surface includes a first gripping portion;
a lower housing, the lower housing including an outer surface, wherein the outer surface of the lower housing includes a second gripping portion that aligns with the first gripping portion of the upper housing and together define a grip;
a second end opposing the first end; and
a neck having a shape configured to deflect cut hair away from the cutter;
wherein the lower housing couples to the upper housing to define a first housing width at the second end and a second housing width at the first end, and wherein the second housing width is greater than the first housing width;
wherein the upper housing further includes a top side and the lower housing further includes a bottom side;
wherein the grip includes a plurality of ridges spaced apart and extending around the handle reaching the bottom side and positioned between the first end and the second end of the cutter.

17. The cutter of claim 16, wherein the neck further includes an upper edge joined to the upper housing, a lower edge opposing the upper edge and a first and second neck edge extending away from opposing sides of the lower edge toward the lower housing.

18. The cutter of claim 17, wherein the first and second neck edge define a first and second side wall of the neck, wherein a neck width is defined between the first and second side walls and wherein the neck width is less than 40% of the second housing width.

19. The cutter of claim 16, wherein the upper housing further including a top surface at the second end of the cutter and a bottom surface at the first end of the cutter, wherein a housing length is defined between the top surface and bottom surface.

20. The cutter of claim 19, wherein the first and second gripping portions extend between a top edge and a bottom edge defining a gripping portion length and wherein the gripping portion length is between 50% and 60% of the housing length.
